(19) United States
(12) Patent Application Publication
(10) Pub. No.: US 2023/0356087 A1
(43) Pub. Date: Nov. 9, 2023

(54) METHOD FOR CONTROLLING VIRTUAL OBJECT TO PICK VIRTUAL PROPS, TERMINAL, AND STORAGE MEDIUM

(71) Applicant: Tencent Technology (Shenzhen) Company Limited, Shenzhen (CN)

(72) Inventor: Qingbo Yu, Shenzhen (CN)

(21) Appl. No.: 18/217,899

(22) Filed: Jul. 3, 2023

Related U.S. Application Data
(63) Continuation of application No. PCT/CN2022/132007, filed on Nov. 15, 2022.

(30) Foreign Application Priority Data
Jan. 24, 2022 (CN) 202210077448.8

(51) Int. Cl. A63F 13/58

(52) U.S. Cl. CPC A63F 13/58

(57) ABSTRACT

Provided are a method for controlling a virtual object to pick virtual props performed by a terminal. The method includes: displaying a prop picking list, the prop picking list comprising prop picking controls of virtual props; receiving an operation on a first prop picking control in the prop picking list; determining a picking mode associated with the operation on the first prop picking control, the picking mode of the first virtual prop comprising (i) picking and using or (ii) picking and carrying; and controlling the virtual object to pick a first virtual prop based on the picking mode associated with the operation. The method can simplify picking operations on virtual props and improve prop picking efficiency.

### CROSS-REFERENCE TO RELATED APPLICATIONS

This application is a continuation application of PCT Patent Application No. PCT/CN2022/132007, entitled “METHOD FOR CONTROLLING VIRTUAL OBJECT TO PICK VIRTUAL PROPS, TERMINAL, AND STORAGE MEDIUM” filed on Nov. 15, 2022, which claims priority to Chinese Patent Application No. 202210077448.8, entitled “METHOD FOR CONTROLLING VIRTUAL OBJECT TO PICK VIRTUAL PROPS, TERMINAL, AND STORAGE MEDIUM” filed on Jan. 24, 2022, all of which is incorporated by reference in its entirety.

### FIELD OF THE TECHNOLOGY

Embodiments of this application relate to the technical field of human-computer interaction, and in particular, to a method for controlling a virtual object to pick virtual props, a terminal, and a storage medium.

### BACKGROUND OF THE DISCLOSURE

In applications based on a three-dimensional virtual environment such as a first-person fighting game, a user may control a virtual object in the virtual environment to perform actions such as walking, running, climbing, and fighting, and multiple users may be grouped online to cooperatively complete a certain task in the same virtual environment.

In the related art, the user may control the virtual object to pick virtual props from the virtual environment, and then use the picked virtual props. Upon receiving a picking operation, a terminal directly replaces a virtual prop in a held state. That is, the virtual object is controlled to discard the currently held virtual prop, and then a new virtual prop is picked and used.

However, if the method in the related art is adopted, the virtual prop may be erroneously discarded, and the user needs to re-pick the erroneously discarded virtual prop. Therefore, the prop picking efficiency is low.

### SUMMARY

Embodiments of this application provide a method for controlling a virtual object to pick virtual props, a terminal, and a storage medium. The technical solutions are as follows:

According to one aspect, the embodiments of this application provide a method for controlling a virtual object to pick virtual props. The method is performed by a terminal. The method includes:
displaying a prop picking list, the prop picking list including prop picking controls of virtual props;
receiving an operation on a first prop picking control in the prop picking list;
determining a picking mode associated with the operation on the first prop picking control, the picking mode of the first virtual prop comprising (i) picking and using or (ii) picking and carrying; and
controlling the virtual object to pick a first virtual prop based on the picking mode associated with the operation.

According to another aspect, the embodiments of this application provide a terminal. The terminal includes a processor and a memory. The memory stores at least one program. The at least one program is loaded and executed by the processor and causing the terminal to implement the method for controlling a virtual object to pick virtual props as described in the foregoing aspect.

According to another aspect, the embodiments of this application provide a non-transitory computer-readable storage medium. The computer-readable storage medium stores at least one computer program. The computer program is loaded and executed by a processor of a terminal and causes the terminal to implement the method for controlling a virtual object to pick virtual props as described in the foregoing aspect.

The technical solutions provided in the embodiments of this application may include at least the following beneficial effects:

In this embodiment of this application, different operations on a first prop picking control can trigger a virtual object to pick a first virtual prop by different picking modes. The picking modes include picking and using or picking and carrying. A user may control use conditions of an owned prop and the first virtual prop by different operations according to actual requirements. Compared with a mode of controlling a virtual object to directly discard virtual props in a used state in the related art, in response to user requirements for controlling the virtual object to use other virtual props, the user may control the virtual object to pick the first virtual prop and equip the first virtual prop to a corresponding state by performing a corresponding operation on the first prop picking control according to the required picking modes without operating and controlling the virtual object to pick the first virtual prop and operating and controlling the virtual object to switch the first virtual prop into a carried state, thereby simplifying picking operations on virtual props and improving prop picking efficiency.

### BRIEF DESCRIPTION OF THE DRAWINGS

FIG. 1 is a schematic diagram of an implementation environment according to an exemplary embodiment of this application.

FIG. 2 is a flowchart of a method for controlling a virtual object to pick virtual props according to an exemplary embodiment of this application.

FIG. 3 is a schematic diagram of a virtual environment interface according to an exemplary embodiment of this application.

FIG. 4 is a flowchart of a method for controlling a virtual object to pick virtual props according to another exemplary embodiment of this application.

FIG. 5 is a schematic diagram of a virtual environment interface according to another exemplary embodiment of this application.

FIG. 6 is a schematic diagram of a virtual environment interface according to another exemplary embodiment of this application.

FIG. 7 is a schematic diagram of a virtual environment interface according to another exemplary embodiment of this application.

FIG. 8 is a flowchart of a swipe event determination process according to an exemplary embodiment of this application.

FIG. 9 is a flowchart of a no-swipe event determination process according to an exemplary embodiment of this application.

FIG. 10 is a flowchart of a method for controlling a virtual object to pick virtual props according to another exemplary embodiment of this application.

FIG. 11 is a schematic diagram of triggering to display a prop replacement control according to an exemplary embodiment of this application.

FIG. 12 is a flowchart of a method for controlling a virtual object to pick virtual props according to another exemplary embodiment of this application.

FIG. 13 is a flowchart of a method for controlling a virtual object to pick virtual props according to another exemplary embodiment of this application.

FIG. 14 is a structural block diagram of an apparatus for controlling a virtual object to pick virtual props according to an exemplary embodiment of this application.

FIG. 15 is a structural block diagram of a terminal according to an exemplary embodiment of this application.

### DESCRIPTION OF EMBODIMENTS

First, the nouns involved in the embodiments of this application are described:

### 1) Virtual Environment

The virtual environment refers to a virtual environment displayed (or provided) when an application is run on a terminal. The virtual environment may be a simulated environment of a real world, a semi-simulated semi-fictional three-dimensional environment, or a purely fictional three-dimensional environment. The virtual environment may be any one of a two-dimensional virtual environment, a 2.5-dimensional virtual environment, and a three-dimensional virtual environment. The following embodiments are illustrated as the virtual environment being a three-dimensional virtual environment, but are not limited thereto. In some embodiments, the virtual environment is further used for a virtual environment battle between at least two virtual objects. In some embodiments, the virtual environment has virtual resources available for the at least two virtual objects.

### 2) Virtual Object

The virtual object refers to an active object in a virtual scene. The active object may be at least one of a virtual person, a virtual animal, and an animated person. In some embodiments, when the virtual scene is a three-dimensional virtual scene, the virtual object may be a three-dimensional stereo model. Each virtual object has a corresponding shape and volume in the three-dimensional virtual scene, and occupies a portion of space in the three-dimensional virtual scene. In some embodiments, the virtual character is a three-dimensional character constructed based on a three-dimensional human skeleton technology, and the virtual character realizes different external images by wearing different skins. In some implementations, the virtual character may also be implemented by using a 2.5-dimensional or 2-dimensional model. The embodiments of this application are not limited thereto.

### 3) Virtual Prop

The virtual prop refers to a prop available for the virtual object in the virtual environment, including at least one of a functional prop and virtual equipment. In this application, the virtual prop is schematically configured to change an attribute value of the virtual object in the virtual environment. For example, the virtual prop includes launching virtual props, close-use virtual props, and casting virtual props.

### 4) User Interface (UI) Control

The UI control refers to any visual control or element viewable on a UI of an application, for example, a picture, an input box, a text box, a button, a tag, and other controls, Some UI controls respond to operations of users.

5) Application Supporting Virtual Environment: The application may be a multiplayer online battle program, for example, any one of a multiplayer online battle arena (MOBA) game, a shooting game, and a simulation game (SLG). The embodiments of this application are illustrated as the application being a shooting game. A game based on a virtual environment is often composed of one or more maps of a game world. The virtual environment in the game simulates real world scenes. A user may manipulate a virtual object in the game to perform actions such as walking, running, jumping, shooting, fighting, driving, picking virtual props, switching to use the virtual props, using the virtual props or virtual skills to attack other virtual objects in the virtual environment.

In the related art, the user may control the virtual object to pick virtual props from the virtual environment, and then use the picked virtual props. In general, the virtual props obtainable by the virtual object are limited. When an owned prop quantity does not reach an upper prop quantity limit, the picked virtual props are stored to idle positions in a prop bar. If the owned prop quantity reaches the upper prop quantity limit, it is necessary to first discard a corresponding quantity of owned props, and a terminal directly replaces the virtual props in a used state. That is, the virtual object is controlled to discard the currently used virtual props, and then new virtual props are picked and used. However, if the method in the related art is adopted, in response to user requirements for replacing the virtual props in the prop bar with new virtual props, it is necessary to first control the virtual object to switch the corresponding virtual props from a carried state to a used state, and then pick the new virtual props. And in response to user requirements for controlling the virtual object to use other virtual props, it is also necessary to control the virtual object to switch the picked virtual props from the used state to the carried state. In addition, if there is an owned prop in a used state, the owned prop will be discarded as the user does not perform state switching in advance. Therefore, there is a case where the owned props are erroneously discarded as the user does not switch prop states of the props in time. Therefore, it is likely to erroneously discard the owned props, and the prop picking efficiency is low.

In order to solve the foregoing technical problems, the embodiments of this application provide a method for controlling a virtual object to pick virtual props.

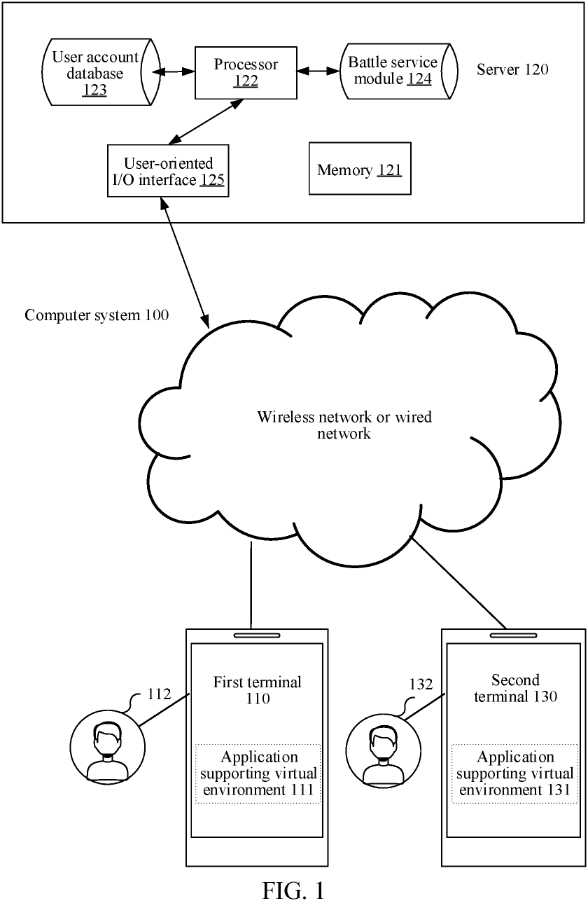

FIG. 1 shows a schematic diagram of an implementation environment according to an embodiment of this application. The implementation environment may include: a first terminal 110, a server 120, and a second terminal 130.

An application 111 supporting a virtual environment is run in the first terminal 110. When the first terminal runs the application 111, a UI of the application 111 is displayed on a screen of the first terminal 110. In this embodiment, the application 111 is illustrated by being a multiplayer battle game. The first terminal 110 is a terminal used by a first user 112. The first user 112 uses the first terminal 110 to control activities of a first virtual object located in a virtual environment. The first virtual object may be referred to as a main control virtual object of the first user 112. The activities of the first virtual object include, but are not limited to, at least one of adjusting body posture, crawling, walking, running, riding, flying, jumping, driving, picking, attacking, throwing, and skill casting. Exemplarily, the first virtual object is a first virtual person, such as a simulated person or an animated person.

An application 131 supporting a virtual environment is run in the second terminal 130. When the second terminal 130 runs the application 131, a UI of the application 131 is displayed on a screen of the second terminal 130. In this embodiment, the application 131 is illustrated by being a multiplayer battle game. The second terminal 130 is a terminal used by a second user 132. The second user 132 uses the second terminal 130 to control activities of a second virtual object located in the virtual environment. The second virtual object may be referred to as a main control virtual object of the second user 132. The activities of the second virtual object include, but are not limited to, at least one of adjusting body posture, crawling, walking, running, riding, flying, jumping, driving, picking, attacking, throwing, and skill casting. Exemplarily, the second virtual object is a second virtual person, such as a simulated person or an animated person.

In some embodiments, the first virtual object and the second virtual object are in the same virtual world. In some embodiments, the first virtual object and the second virtual object may belong to the same camp, the same team and the same organization, have a friend relationship, or have a temporary communication permission. In some embodiments, the first virtual object and the second virtual object may belong to different camps, different teams and different organizations, or have an adversarial relationship.

In some embodiments, the applications installed on the first terminal 110 and the second terminal 130 are the same, or the applications installed on the two terminals are the same type of applications on different operating system platforms (Android or IOS). The first terminal 110 may generally refer to one of multiple terminals, and the second terminal 130 may generally refer to another of the multiple terminals. This embodiment is exemplified only by the first terminal 110 and the second terminal 130. The first terminal 110 and the second terminal 130 have the same or different device types. The device types include: at least one of a smartphone, a tablet computer, an e-book reader, an MP3 player, an MP4 player, a laptop portable computer, and a desktop computer.

Only two terminals are shown in FIG. 1. However, in different embodiments, there are multiple other terminals having access to the server 120. In some embodiments, there are also one or more terminals corresponding to a developer. A development and editing platform for an application supporting a virtual environment is installed on the terminal. The developer may edit and update the application on the terminal, and transmit an updated application installation package to the server 120 through a wired or wireless network. The first terminal 110 and the second terminal 130 may download the application installation package from the server 120 to implement the update of the application.

The first terminal 110, the second terminal 130, and the other terminals are connected to the server 120 through the wireless network or the wired network.

The server 120 includes at least one of a server, a server cluster composed of multiple servers, a cloud computing platform, and a virtualization center. The server 120 is configured to provide a background service for the application supporting the three-dimensional virtual environment. In some embodiments, the server 120 undertakes primary computing tasks, and the terminal undertakes secondary computing tasks. Or, the server 120 undertakes secondary computing tasks, and the terminal undertakes primary computing tasks. Or, the server 120 and the terminal perform cooperative computing using a distributed computing architecture.

In a schematic example, the server 120 includes a memory 121, a processor 122, a user account database 123, a battle service module 124, and a user-oriented input/output (I/O) interface 125. The processor 122 is configured to load an instruction stored in the server 120 and process data in the user account database 123 and the battle service module 124. The user account database 123 is configured to store data of user accounts used by the first terminal 110, the second terminal 130, and other terminals, such as avatars of the user accounts, nicknames of the user accounts, owned virtual props of the user accounts, and service areas where the user accounts are located. The battle service module 124 is configured to provide multiple battle rooms for users to battle, such as a 1V1 battle, a 3V3 battle, or a 5V5 battle. The user-oriented I/O interface 125 is configured to communicate data with the first terminal 110 and/or the second terminal 130 through the wireless network or the wired network.

The method for controlling a virtual object to pick virtual props in this application may be performed by a terminal supporting a virtual environment alone, and the method may also be performed by a server corresponding to an application supporting a virtual environment alone. The method may also be performed cooperatively by the terminal and the server. The following various method embodiments are illustrated as the method being performed by the terminal alone.

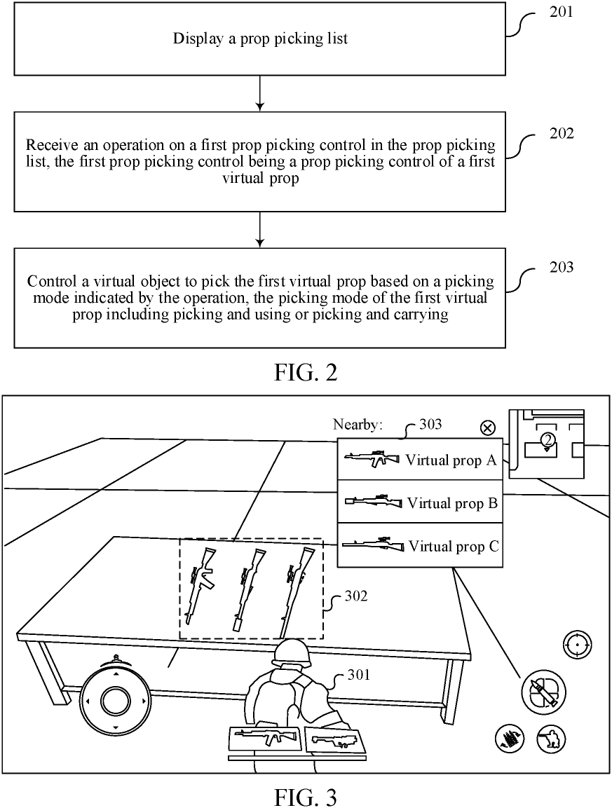

FIG. 2 shows a flowchart of a method for controlling a virtual object to pick virtual props according to an exemplary embodiment of this application. This embodiment is illustrated as the method being applied to the first terminal 110 or the second terminal 130 in the implementation environment shown in FIG. 1 or other terminals in the implementation environment. The method includes the following steps:

Step 201: Display a prop picking list.

The prop picking list includes prop picking controls corresponding to virtual props. The virtual props refer to props which are scattered in a virtual environment, do not belong to any virtual object, and are pickable by a controlled virtual object corresponding to a terminal and other virtual objects in the virtual environment. After being picked by the virtual object, the virtual props are owned props of the virtual object.

In a possible implementation, in the presence of virtual props in the virtual environment at the periphery of (around) the virtual object, the terminal displays a prop picking list through a virtual environment interface to present the virtual props pickable by the virtual object currently to a user. For example, when detecting the presence of a virtual prop at a position less than or equal to 5 m from the virtual object, the terminal displays the prop picking list. The prop picking list includes prop picking controls corresponding to various virtual props at the periphery of (around) the virtual object. The user enables the terminal to control a first virtual object to pick the corresponding virtual props by operating the prop picking controls in the prop picking list.

In some embodiments, the terminal automatically displays the prop picking list when a distance between the virtual object and the virtual prop is less than a distance threshold, and automatically cancels the display of the prop picking list when the distance between the virtual object and the virtual prop is greater than the distance threshold. Or, the user may manually control the terminal to present or close the prop picking list. When a trigger operation on the prop picking list is received, the terminal displays the prop picking list. The trigger operation may be a trigger operation on a list presentation control, a trigger operation of a preset operation type, a voice trigger operation, or the like. This embodiment of this application is not limited thereto.

FIG. 3 schematically shows a virtual environment interface on which a prop picking list is displayed. A virtual prop 302 exists at the periphery of a virtual object 301. The terminal displays a prop picking list 303 via a virtual environment interface. The prop picking list 303 includes prop picking controls corresponding to three virtual props 302.

Step 202: Receive an operation on a first prop picking control in the prop picking list, the first prop picking control being a prop picking control of a first virtual prop.

The prop picking controls in the prop picking list correspond to the virtual props one by one. The prop picking control which receives an operation is a first prop picking control, and the virtual prop corresponding to the first prop picking control is a first virtual prop. Upon receiving the operation on the first prop picking control, the terminal controls the virtual object to pick the first virtual prop from the virtual environment.

In a possible implementation, the operation on the first prop picking control is an operation in which an operation starting point is located within the first prop picking control and an operation type satisfies a control trigger condition. Different control trigger conditions (operation types) correspond to different picking modes. After receiving the operation on the first prop picking control, the terminal determines the picking mode based on the operation type.

Step 203: Control a virtual object to pick the first virtual prop based on a picking mode indicated by the operation, the picking mode of the first virtual prop including picking and using or picking and carrying.

The owned prop of the virtual object exists in two states: used and carried. The owned prop in the used state refers to a prop available by the virtual object directly for changing attribute values of other virtual objects (for example, handheld, foot-held, bound, or installed in a certain part of the virtual object). That is, when the terminal receives an operation on a prop using control, the terminal controls the virtual object to change the attribute values of other virtual objects through the owned prop in the used state. The owned prop in the carried state refers to a prop unavailable by the virtual object directly for changing the attribute values of other virtual objects (for example, the virtual object is borne or hidden to the prop bar). The owned prop in the carried state may be switched to the used state, and the owned prop in the used state may be switched to the carried state. The picking mode of virtual props by the virtual object includes picking and using, and picking and carrying. The mode of picking and using refers to picking a virtual prop and equipping the virtual prop to the used state. The mode of picking and carrying refers to picking a virtual prop and equipping the virtual prop to the carried state.

In a possible implementation, the terminal controls the virtual object to pick, based on a picking mode indicated by the operation, the first virtual prop in the picking mode. For example, the user clicks/taps the first prop picking control, whereby the terminal controls the virtual object to pick and hold the first virtual prop. The corresponding picking mode is picking and using. The user swipes the first prop picking control rightwards, whereby the terminal controls the virtual object to pick the first virtual prop and bear the first virtual prop. The corresponding picking mode is picking and carrying.

In some embodiments, the terminal may control the virtual object to pick the first virtual prop according to the received operation, and a server may also control the virtual object to pick the first virtual prop. The terminal may report the received operation to the server, and the server determines the picking mode corresponding to the operation, controls the first virtual object to pick the first virtual prop, and then feeds back a display picture for picking the first virtual prop to the terminal, whereby the terminal displays a picture display process for controlling the virtual object to pick the first virtual prop.

To sum up, in this embodiment of this application, different operations on a first prop picking control can trigger a virtual object to pick a first virtual prop by different picking modes. The picking modes include picking and using or picking and carrying. A user may control use conditions of an owned prop and the first virtual prop by different operations according to actual requirements. Compared with a mode of controlling a virtual object to directly discard virtual props in a used state in the related art, in response to user requirements for controlling the virtual object to use other virtual props, the user may control the virtual object to pick the first virtual prop and equip the first virtual prop to a corresponding state by performing a corresponding operation on the first prop picking control according to the required picking modes without operating and controlling the virtual object to pick the first virtual prop and operating and controlling the virtual object to switch the first virtual prop into a carried state, thereby simplifying picking operations on virtual props and improving prop picking efficiency.

In order to distinguish different picking modes, different operations are set for the different picking modes. In a possible implementation, the operation on the first prop picking control includes a first operation and a second operation. The two operations have different operation types corresponding to the different picking modes. For example, the first operation may be a click/tap operation, and the second operation may be a swipe operation.

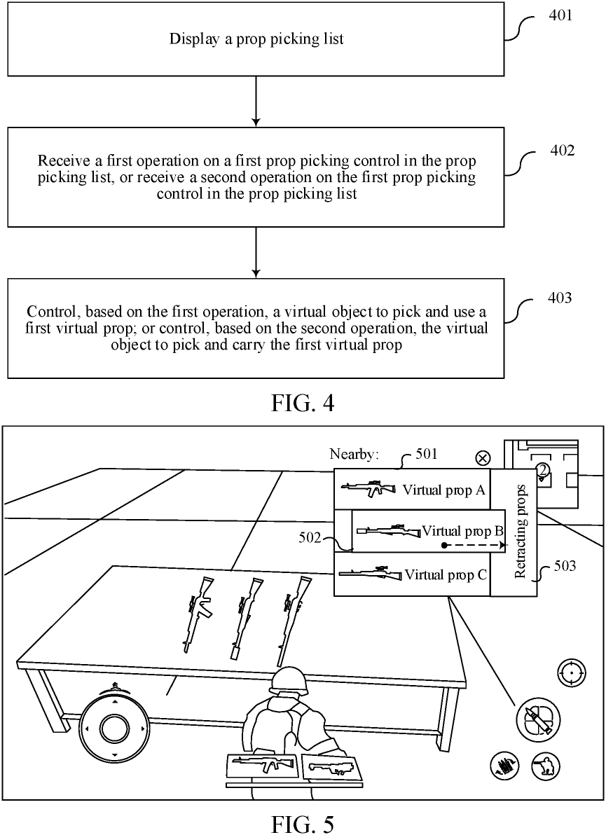

FIG. 4 shows a flowchart of a method for controlling a virtual object to pick virtual props according to another exemplary embodiment of this application. This embodiment is illustrated as the method being applied to the first terminal 110 or the second terminal 130 in the implementation environment shown in FIG. 1 or other terminals in the implementation environment. The method includes the following steps:

Step 401: Display a prop picking list.

A specific implementation of step 401 is similar to that of step 201, and is not described again in this embodiment of this application.

Step 402: Receive a first operation on a first prop picking control in the prop picking list, or receive a second operation on the first prop picking control in the prop picking list.

Operation types of the first operation and the second operation are different, and the operation types of the first operation and the second operation include the following:

the first operation is a click/tap operation, and the second operation is a swipe operation.

Schematically, the first operation is a one-click/tap operation, a double-click/tap operation, a one-finger click/tap operation, or a double-finger click/tap operation, or the like. The second operation is a right-swipe operation, a left-swipe operation, a one-finger swipe operation, a double-finger swipe operation, or the like. The first operation and the second operation may select a combination between any click/tap operation and any swipe operation, for example: one-click/tap operation + right-swipe operation, one-click/tap operation + left-swipe operation, one-click/tap operation + one-finger swipe operation, one-click/tap operation + double-finger swipe operation, double-click/tap operation + right-swipe operation, double-click/tap operation + left-swipe operation, double-click/tap operation + one-finger swipe operation, double-click/tap operation + double-finger swipe operation, and the like. This embodiment of this application is not limited thereto. For example, the first operation is a one-click/tap operation, and the second operation is a right-swipe operation. A user clicks/taps the first prop picking control, the terminal controls a first virtual object to pick and use a first virtual prop, the user performs the right-swipe operation on the first prop picking control, and the terminal controls the first virtual object to pick and carry the first virtual prop.

Or, the first operation is a first swipe operation, the second operation is a second swipe operation, and swipe directions of the first swipe operation and the second swipe operation are different.

Schematically, the first operation is a left-swipe operation, and the second operation is a right-swipe operation; or the first operation is a right-swipe operation, and the second operation is a left-swipe operation; or the first operation is an up-swipe operation, and the second operation is a down-swipe operation; or the first operation is a down-swipe operation, and the second operation is an up-swipe operation, and the like. This embodiment of this application is not limited thereto.

Or, swipe distances of the first swipe operation and the second swipe operation are different. Schematically, the first swipe operation and the second swipe operation are both left-swipe operations, but a first swipe distance of the first swipe operation is less than a second swipe distance of the second swipe operation; or the first swipe distance of the first swipe operation is greater than the second swipe distance of the second swipe operation.

Or, the first operation is a first click/tap operation, the second operation is a second click/tap operation, and clicks/taps of the first click/tap operation and the second click/tap operation are different.

Schematically, the first operation is a one-click/tap operation, and the second operation is a double-click/tap operation; or the first operation is a double-click/tap operation, and the second operation is a one-click/tap operation; or the first operation is a one-finger click/tap operation, and the second operation is a double-finger click/tap operation, and the like. This embodiment of this application is not limited thereto.

In other possible implementations, the first operation and the second operation may also be other types of operations. For example, the first operation is a swipe operation, and the second operation is a click/tap operation. The first operation is a click/tap operation, and the second operation is a long-press operation, and the like.

Step 403: Control, based on the first operation, the virtual object to pick and use a first virtual prop; or control, based on the second operation, the virtual object to pick and carry the first virtual prop.

The first operation corresponds to a picking mode of picking and using, and the second operation corresponds to a picking mode of picking and carrying. The terminal determines, based on the operation type, whether the operation on the first prop picking control belongs to the first operation or the second operation, and then controls the virtual object to pick and use the first virtual prop, or pick and carry the first virtual prop.

In a possible implementation, when the first operation or the second operation is a swipe operation, the method for controlling a virtual object to pick virtual props according to this embodiment of this application further includes the following steps:

displaying a prompt control around the prop picking list, a display position of the prompt control corresponding to a swipe direction of the swipe operation, prop picking information being displayed in the prompt control, and the prop picking information being used for indicating the picking mode of the first virtual prop.

If the first operation or the second operation is a swipe operation, when it is detected that a swipe starting point is located in the first prop picking control and a swipe direction conforms to the swipe operation of the first operation or the second operation, the terminal displays a prompt control at the periphery of (around) the prop picking list based on the swipe direction. The prompt control displays prompt information for indicating the picking mode. The terminal displays the prompt control to prompt the user how the virtual object will pick the first virtual prop after the current operation is completed, whereby the user determines whether to continue the operation, thereby avoiding misoperation to control the first virtual object to adopt an erroneous picking mode.

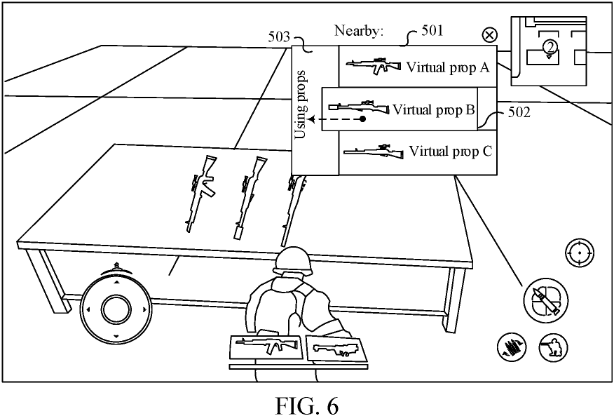

Schematically, as shown in FIG. 5 and FIG. 6, the first operation is a left-swipe operation, and the second operation is a right-swipe operation. In order to prompt the user of picking modes corresponding to two operations, when receiving a right-swipe operation on a first prop picking control 502, the terminal displays a prompt control 503 on the right side of a prop picking list 501. At this moment, prompt information in the prompt control 503 is “retracting props”, and the prompt information is picking and carrying correspondingly. When receiving a left-swipe operation on the first prop picking control 502, the terminal displays the prompt control 503 on the left side of the prop picking list 501. At this moment, prompt information in the prompt control 503 is “using props”, and the prompt information is picking and using correspondingly.

In another possible implementation, owned props of the virtual object have an upper quantity limit, and when an owned prop quantity reaches the upper quantity limit, the virtual object re-picks a virtual prop and replaces the owned prop. If the first virtual prop is picked according to the picking mode indicated by the operation and the corresponding owned prop needs to be replaced, the prompt information further includes a prop identifier of the replaced owned prop. It is convenient for the user to know which owned prop is to be replaced, without observing and thinking about the replacement of props, so as to reduce the situation of discarding the required owned prop erroneously on the basis of improving the prop picking efficiency. If the user does not want to replace the owned prop, the operation may be stopped.

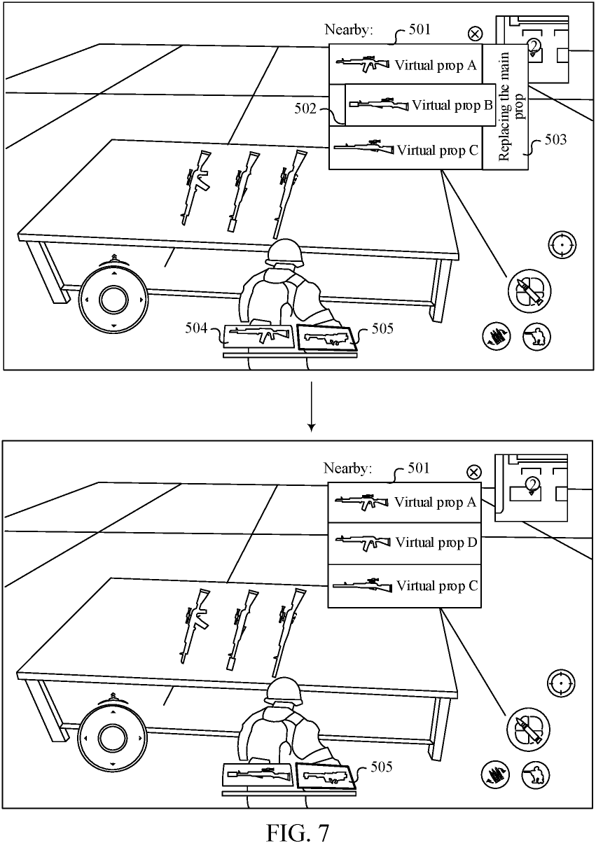

As shown in FIG. 7, the current virtual object is using an auxiliary prop 505 in the owned props, while a main prop 504 in the owned props is in a carried state. When receiving a second operation on the first prop picking control 502, the terminal determines that the main prop 504 in the carried state needs to be replaced, and displays the prompt control 503. The prompt control 503 includes prompt information “replacing the main prop”.

In this embodiment of this application, different types of operations are set for two picking modes, whereby a user may control a virtual object to pick a first virtual prop and determine a prop state of the first virtual prop after the first virtual prop is picked by only one operation on a first prop picking control. Compared with a fixed prop picking mode, the user does not need to adjust a prop state of an owned prop to avoid affecting other owned props, thereby simplifying an operation flow of controlling a virtual object to pick virtual props and improving operation efficiency.

In a possible implementation, when the first operation or the second operation is a swipe operation in a target direction, step 202 includes the following steps:

Step 202a: Receive the swipe operation acting on the target direction of the first prop picking control.

When the swipe operation acting on the target direction of the first prop picking control (an operation starting point is located inside the first prop picking control) is detected, the terminal detects a swipe event, and determines whether the swipe event belongs to the first operation or the second operation.

Step 202b: Determine that the operation on the first prop picking control is received in response to the end of the swipe operation and a swipe distance being greater than or equal to a first distance threshold.

The terminal determines whether the swipe event takes effect based on the swipe distance of the swipe operation, namely, determining whether the swipe operation belongs to the first operation or the second operation. The terminal determines that the operation on the first prop picking control is received in response to the end of the swipe operation and the swipe distance being greater than or equal to the first distance threshold.

The unit of the swipe distance is device independent pixels (DP). The calculation formula is DP coefficient = screen pixel density / 160. The advantage of using DP as the unit of the swipe distance is that when adapting to models with different pixel densities in the process of application development, the physical size of the same control displayed by terminals of various models may be uniform, thereby facilitating the determination of swipe events using a uniform distance threshold.

Accordingly, the method for controlling a virtual object to pick virtual props according to this embodiment of this application further includes the following steps:

determining that the swipe operation does not belong to the operation on the first prop picking control in response to the end of the swipe operation and the swipe distance being less than the first distance threshold.

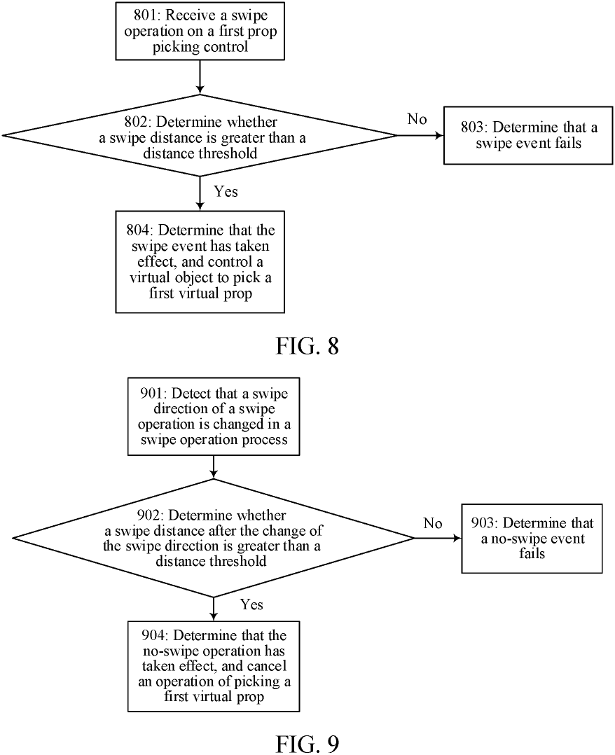

Schematically, as shown in FIG. 8, the process of determining, by the terminal, whether a swipe event has taken effect includes the following steps: Step 801: Receive a swipe operation on a first prop picking control. Step 802: Determine whether a swipe distance is greater than a distance threshold. If yes, step 804 is performed. If no, step 803 is performed. Step 803: Determine that a swipe event fails. Step 804: Determine that the swipe event has taken effect, and control a virtual object to pick a first virtual prop.

It is determined that the swipe operation does not belong to operations on the first prop picking control in response to a side direction of the swipe operation being changed and the swipe distance after direction change being greater than or equal to a second distance threshold.

The terminal determines that the swipe event fails when the swipe operation does not end, the side direction of the swipe operation is changed, and the swipe distance after direction change is greater than or equal to the second distance threshold. The swipe operation does not belong to a first operation or a second operation. That is, when the operation does not end, a user may cancel the first operation or the second operation by reverse sliding, so as to reduce the situation that virtual props are picked erroneously.

In some embodiments, the second distance threshold may be less than or equal to the first distance threshold. That is, a larger distance threshold is required to determine that the swipe event has taken effect. As long as the swipe direction is changed, it may be determined that the swipe event fails even if the swipe distance is small, so as to improve the threshold for the swipe event taking effect, improve the accuracy of determining that the swipe event is an active swipe event of the user, and avoid a wrong prop picking operation caused by accidental touch.

For example, the second operation is a right-swipe operation, and the terminal receives a right-swipe operation on the first prop picking control. When the terminal detects that the swipe operation is converted to a left-swipe operation and a left-swipe distance is greater than the second distance threshold, it is determined that the swipe operation does not belong to the operations on the first prop picking control.

Schematically, as shown in FIG. 9, the process of determining, by the terminal, whether a no-swipe event has taken effect includes the following steps: Step 901: Detect that a swipe direction of a swipe operation is changed in a swipe operation process. Step 902: Determine whether a swipe distance after the change of the swipe direction is greater than a distance threshold. If yes, step 904 is performed. If no, step 903 is performed. Step 903: Determine that a no-swipe event fails. Step 904: Determine that the no-swipe event has taken effect, and cancel an operation of picking a first virtual prop.

Compared to the picking mode of props, the user may be more concerned about an owned prop that needs to be discarded by a virtual object and replaced by the first virtual prop after the first virtual prop is picked. In a possible implementation, the terminal is provided with a prop replacement selection mechanism. The user may select an owned prop to be replaced, and the terminal automatically determines a picking mode based on a prop state of the replaced prop, and controls the first virtual object to pick the first virtual prop and to replace the corresponding owned prop.

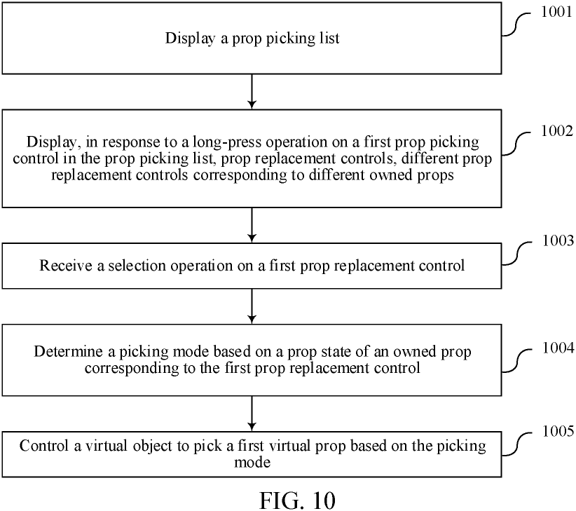

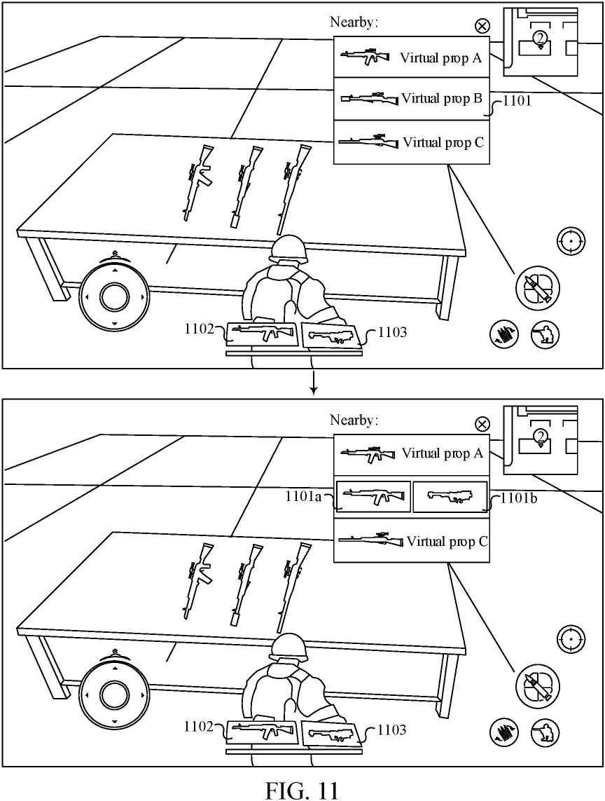

FIG. 10 shows a flowchart of a method for controlling a virtual object to pick virtual props according to another exemplary embodiment of this application. This embodiment is illustrated as the method being applied to the first terminal 110 or the second terminal 130 in the implementation environment shown in FIG. 1 or other terminals in the implementation environment. The method includes the following steps:

Step 1001: Display a prop picking list.

A specific implementation of step 1001 is similar to that of step 201, and is not described again in this embodiment of this application.

Step 1002: Display, in response to a long-press operation on a first prop picking control in the prop picking list, prop replacement controls, different prop replacement controls corresponding to different owned props.

In a possible implementation, when an operation on a first prop is a long-press operation, display of the prop replacement control and selection operation on the prop replacement control may be triggered. After determining a first virtual prop to be picked, a user long-presses a first prop picking control corresponding to the first virtual prop and activates the terminal to display a prop replacement control corresponding to the first prop picking control. The prop replacement control is configured to trigger replacement of a corresponding owned prop with the first virtual prop.

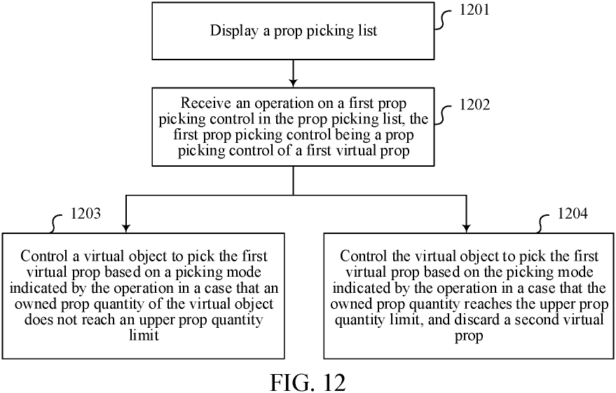

Schematically, as shown in FIG. 11, upon receiving a long-press operation on a first prop picking control 1101, the terminal switches display of the first prop picking control 1101 as a first prop replacement control 1101a and a second prop replacement control 1101b. The first prop replacement control 1101a is configured to trigger the replacement of a corresponding main prop 1102 with a first virtual prop. The second prop replacement control 1101b is configured to trigger the replacement of a corresponding auxiliary prop 1103 with the first virtual prop. Prop identifiers (images) of corresponding owned props are displayed within the prop replacement controls, whereby a user quickly determines a picking mode and complete an operation.

In another possible implementation, the prop replacement controls correspond to prop storage positions one by one, and the prop replacement controls are configured to trigger the replacement of the owned props at the corresponding prop storage positions. When the prop storage positions are in an idle state, idle marks are displayed within the prop replacement controls (the idle marks are used for representing that the corresponding prop storage positions are in the idle state).

In some embodiments, when displaying prop replacement controls, the terminal may display the corresponding prop replacement controls for all owned props. Or, the prop replacement controls of only a portion of the owned props may be displayed to reduce the difficulty in selecting prop replacement controls by the user.

In some embodiments, when displaying the prop replacement controls of a portion of the owned props, the terminal may select a to-be-replaced owned prop from all virtual props owned by a main control virtual object of the user. When selecting replaceable owned props, a virtual prop belonging to the same prop type as the first virtual prop may be selected, or a virtual prop similar to an attack type of the first virtual prop may be selected, or a virtual prop having the same usage mode as the first virtual prop may be selected, or a virtual prop with a lower prop priority may be selected preferentially. The prop priority may be related to a historical usage frequency of the virtual prop (as the historical usage frequency is lower, the prop priority is lower), or may be related to an attack strength of the virtual prop (as the attack strength is lower, the prop priority is lower), or may be related to an attack range of the virtual prop (as the attack range is smaller, the prop priority is lower), and the like.

Step 1003: Receive a selection operation on a first prop replacement control.

In some embodiments, the selection operation is a click/tap operation, a long-press operation, a swipe operation, a drag operation, or the like. This embodiment of this application is not limited thereto.

Step 1004: Determine a picking mode based on a prop state of an owned prop corresponding to the first prop replacement control.

Since the operation on the prop picking control by the user indicates the replaced owned prop, the terminal needs to determine the picking mode of the first virtual prop according to the prop state of the owned prop corresponding to the first prop replacement control, whereby the state of the picked first virtual prop is consistent with the prop state of the replaced owned prop, thereby avoiding affecting owned props in other states.

In a possible implementation, step 1004 includes the following step:

Step 1004a: Determine that the picking mode is picking and using when the prop state is a used state.

Step 1004b: Determine that the picking mode is picking and carrying when the prop state is a non-used state.

The used state of the prop refers to a state in which the virtual object may directly use the virtual prop to change attribute values of other virtual objects (for example, handheld, foot-held, bound, or installed in a certain part of the virtual object). That is, when the terminal receives an operation on a prop using control, the terminal controls the virtual object to change the attribute values of other virtual objects through the owned prop in the used state. The non-used state of the prop refers to a state in which the virtual object cannot directly use the virtual prop to change the attribute values of other virtual objects (for example, the virtual object is borne or hidden to a prop bar). The non-used state may also be referred to as a carried state. The owned prop in the non-used state may be switched to the used state, and the owned prop in the used state may be switched to the non-used state.

The terminal determines the picking mode, whereby the prop state of the picked first virtual prop is consistent with the prop state of the owned prop corresponding to the first prop replacement control. Schematically, the owned props of the virtual object include a main prop and an auxiliary prop. The main prop is in a non-used state, and the auxiliary prop is in a used state. After receiving a trigger operation on a prop replacement control corresponding to the main prop, since the main prop is in the non-used state, the replaced first virtual prop shall also be in the non-used state, and the terminal correspondingly determines that the picking mode of the first virtual prop is picking and carrying. In some embodiments, after receiving a trigger operation on a prop replacement control corresponding to the auxiliary prop, since the auxiliary prop is in the used state, the replaced first virtual prop shall also be in the used state, and it is correspondingly determined that the picking mode of the first virtual prop is picking and using.

In another possible implementation, the prop replacement controls correspond to prop storage positions one by one, and the prop replacement controls are configured to trigger the replacement of the owned props at the corresponding prop storage positions. When the prop storage positions are in an idle state, idle marks are displayed within the prop replacement controls (the idle marks are used for representing that the corresponding prop storage positions are in the idle state).

Therefore, when the owned prop corresponding to the first prop replacement control exists, the terminal performs step 1004a or step 1004b. When the owned prop corresponding to the first prop replacement control does not exist, the terminal determines the picking mode based on the prop state of another owned prop. If the owned prop in the used state exists, it is determined that the picking mode is picking and carrying. If the owned prop in the used state does not exist, it is determined that the picking mode is a default picking mode (picking and using, or picking and carrying).

Step 1005: Control the virtual object to pick a first virtual prop based on the picking mode.

In some embodiments, the terminal controls the virtual object to pick the first virtual prop based on the picking mode, and controls the virtual object to discard the owned prop corresponding to the first prop replacement control, or switches the owned prop corresponding to the first prop replacement control from the used state to the non-used state when the picking mode is picking and using.

In some embodiments, the state of the replaced owned prop may be determined according to a prop quantity of the owned props of the virtual object. If the prop quantity of the owned props of the virtual object does not reach an upper prop quantity limit, the owned prop corresponding to the first prop replacement control may be switched from the used state to the non-used state without being discarded. If the prop quantity of the owned props of the virtual object reaches the upper prop quantity limit, the owned prop corresponding to the first prop replacement control may be directly discarded.

In this embodiment of this application, a picking mode is determined based on a prop state of an owned prop corresponding to a first prop replacement control, whereby a user may directly select a prop needing to be replaced without observing and thinking about how to select the picking mode, thereby avoiding the case where an owned prop still needing to be used is discarded erroneously caused by a picking mode selection error, and the replacement of the owned prop and the picking of a first virtual prop may be completed by one operation, so as to further improve the efficiency and accuracy of controlling a virtual object to pick a virtual prop.

FIG. 12 shows a flowchart of a method for controlling a virtual object to pick virtual props according to another exemplary embodiment of this application. This embodiment is illustrated as the method being applied to the first terminal 110 or the second terminal 130 in the implementation environment shown in FIG. 1 or other terminals in the implementation environment. The method includes the following steps:

Step 1201: Display a prop picking list.

Step 1202: Receive an operation on a first prop picking control in the prop picking list, the first prop picking control being a prop picking control of a first virtual prop.

Specific implementations of step 1201 to step 1202 are similar to the above embodiments, and will not be described in detail in this embodiment of this application.

Step 1203: Control the virtual object to pick the first virtual prop based on a picking mode indicated by the operation when an owned prop quantity of the virtual object does not reach an upper prop quantity limit.

If there is an upper limit on the quantity of owned props of the virtual object, for example, the upper prop quantity limit is 5, the virtual object can have up to five virtual props. When the owned prop quantity of the virtual object does not reach the upper prop quantity limit, the virtual object may continue to pick the virtual prop. When the owned prop quantity of the virtual object reaches the upper prop quantity limit, the terminal needs to control the virtual object to discard the corresponding quantity of owned virtual props, and then to pick the first virtual prop. Therefore, after picking the first virtual prop based on the picking mode indicated by the operation, it is also necessary to determine whether to discard a second virtual prop in the owned props based on a relationship between the owned prop quantity of the virtual object and the upper prop quantity limit. If the owned prop quantity of the virtual object does not reach the upper prop quantity limit, the second virtual prop may not need to be discarded when the first virtual prop is picked according to the picking mode. Conversely, if the owned prop quantity of the virtual object reaches the upper prop quantity limit, the second virtual prop may need to be discarded while the first virtual prop is picked according to the picking mode.

The owned prop quantity herein is the quantity of virtual props owned by the virtual object before the first virtual prop is picked.

In a possible implementation, an upper limit of owned props in a used state is 1, when the picking mode is picking and using, step 1203 includes the following steps:

Step 1203a: Control the virtual object to pick and use the first virtual prop when the owned prop quantity does not reach the upper prop quantity limit and the virtual object does not use a virtual prop.

When the first virtual prop is picked according to the picking mode, if the picking mode of the first virtual prop is picking and using, it is necessary to determine whether the prop state of another virtual prop needs to be changed according to whether the virtual object uses the virtual prop since the virtual object cannot use two virtual props at the same time. In a possible implementation, the terminal directly controls the virtual object to pick and use the first virtual prop when the picking mode is picking and using when the owned prop quantity does not reach the upper prop quantity limit and the virtual object does not use the virtual prop.

For example, the virtual object has at most one main prop and one auxiliary prop. When the virtual object has only one main prop and the main prop is in a non-used state, when receiving an operation in which the picking mode is picking and using, the terminal controls the virtual object to pick the first virtual prop and uses the first virtual prop as the auxiliary prop.

Step 1203b: Control, when the owned prop quantity does not reach the upper prop quantity limit and a third virtual prop is in a used state, the virtual object to switch the third virtual prop to a non-used state. The virtual object is controlled to pick and use the first virtual prop.

When the owned prop quantity does not reach the upper prop quantity limit and the third virtual prop is in the used state, when the picking mode is picking and using, since the virtual object cannot use multiple virtual props at the same time, the terminal needs to control the virtual object to switch the owned prop (namely, the third virtual prop) in the used state to the non-used state, and then to pick and use the first virtual prop.

For example, the virtual object has at most one main prop and one auxiliary prop. When the virtual object has only one main prop and the main prop is in a used state, when receiving an operation in which the picking mode is picking and using, the terminal controls the virtual object to switch the main prop from the used state to the non-used state (for example, switch from a handheld state to a borne state), picks the first virtual prop, and uses the first virtual prop as the auxiliary prop.

In a possible implementation, when the picking mode is picking and carrying, step 1103 includes the following steps:

Step 1203c: Control the virtual object to pick and carry the first virtual prop when the owned prop quantity does not reach the upper prop quantity limit.

Since the picking mode of picking and carrying does not affect the owned props in the used state, that is, regardless of whether there are the owned props in the used state, the virtual object may directly pick and carry the first virtual prop without changing the state of another owned prop when the owned prop quantity does not reach the upper prop quantity limit.

For example, the virtual object has at most one main prop and one auxiliary prop. When the virtual object has only one main prop, if receiving an operation in which the picking mode is picking and carrying, the terminal controls a first virtual object to pick the first virtual prop and carries the first virtual prop as the auxiliary prop.

Step 1204: Control the virtual object to pick the first virtual prop based on the picking mode indicated by the operation when the owned prop quantity reaches the upper prop quantity limit, and discard a second virtual prop.

When the owned prop quantity reaches the upper prop quantity limit, the terminal cannot directly control the virtual object to continue to pick the virtual prop, but needs to control the virtual object to discard the second virtual prop and then pick the first virtual prop.

The second virtual props are different with different prop equipment. In a possible implementation, when the picking mode is picking and using, if there is no owned prop in the used state, step 1104 includes the following steps:

Step 1204a: Determine the second virtual prop from owned props in a non-used state when the owned prop quantity reaches the upper prop quantity limit and the virtual object does not use a virtual prop.

Step 1204b: Control the virtual object to discard the second virtual prop.

Step 1204c: Control the virtual object to pick and use the first virtual prop.

When the owned prop quantity reaches the upper prop quantity limit, the terminal needs to control the virtual object to discard a corresponding quantity of owned props if the first virtual object is controlled to continue to pick the virtual prop. If the virtual object does not use the virtual prop, namely, there is no owned prop in the used state, the terminal needs to determine the second virtual prop from the owned props in the non-used state, and control the virtual object to discard the second virtual prop and then pick the first virtual prop.

For example, the owned props of the virtual object include a main prop and an auxiliary prop, and the quantity reaches the upper prop quantity limit. If the virtual object does not use the virtual prop and the terminal receives an operation in which the picking mode is picking and using, the terminal determines a second virtual prop from the main prop and the auxiliary prop.

In some embodiments, the second virtual prop is a default prop (for example, the main prop), or the terminal determines the second virtual prop from the owned props in the non-used state based on the prop priority of each owned prop. The prop priority of the second virtual prop is lower than the prop priority of another owned prop. In some embodiments, the prop priority may be determined by a usage frequency of the owned prop (as the usage frequency is lower, the prop priority is lower), or the prop priority may be determined by a prop action strength of the owned prop (as the prop action strength is larger, the prop priority is higher), or the prop priority may be determined by a prop action range of the owned prop (as the prop action range is larger, the prop priority is higher).

In some embodiments, the quantity of second virtual props to be discarded by the virtual object under the control of the terminal is determined by the quantity of picked first virtual props. For example, if two first virtual props need to be picked, two second virtual props need to be discarded.

In a possible implementation, when the picking mode is picking and using, if there is an owned prop in the used state, step 1204 includes the following steps:

Step 1204d: Control the virtual object to discard the second virtual prop when the owned prop quantity reaches the upper prop quantity limit and the second virtual prop is in a used state.

Step 1204e: Control the virtual object to pick and use the first virtual prop.

When the owned prop quantity reaches the upper prop quantity limit and there is a second virtual prop in a used state, when receiving an operation in which the picking mode is picking and using, the terminal determines the owned prop in the used state as the second virtual prop, controls the virtual object to discard the second virtual prop, and then picks and uses the first virtual prop.

For example, the owned props of the virtual object include a main prop and an auxiliary prop, and the quantity reaches the upper prop quantity limit. If the virtual object is using the main prop and the terminal receives an operation in which the picking mode is picking and using, the terminal controls the virtual object to discard the main prop, picks the first virtual prop, and uses the first virtual prop as the main prop.

In a possible implementation, when the picking mode is picking and carrying, step 1104 includes the following steps:

Step 1204f: Determine the second virtual prop from owned props in a non-used state when the owned prop quantity reaches the upper prop quantity limit.

Step 1204g: Control the virtual object to discard the second virtual prop.

Step 1204h: Control the virtual object to pick and carry the first virtual prop.

When the owned prop quantity reaches the upper prop quantity limit, when a user selects the picking mode as picking and carrying, the owned props in the used state are generally more important props, and the user is likely to need to control the virtual object to continue using the props. Therefore, to avoid affecting the owned props in the used state, the terminal determines the second virtual prop from the owned props in the non-used state.

In the above last two prop picking scenarios, after receiving the operation on the first prop picking control, the terminal first needs to determine the second virtual prop from the owned props in the non-used state. The determination process of the second virtual prop includes the following steps:

determining the second virtual prop from the owned props in the non-used state based on prop priority of the owned props, the prop priority of the second virtual prop being lower than the prop priority of another owned prop.

The prop priority is determined based on a priority setting operation; or the prop priority of the owned prop of the same type as the first virtual prop is lower than the prop priority of the owned prop of a different type than the first virtual prop; or the prop priority is positively correlated with a prop action strength of the owned prop; or the prop priority is positively correlated with a prop action range of the owned prop.

The discarded owned prop is typically a virtual prop that is not needed by the user. In a possible implementation, the terminal determines an owned prop with the lowest prop priority as the second virtual prop.

In some embodiments, the prop priority is determined based on a priority setting operation. For example, the user may set the prop priority of each type of virtual prop, and the terminal determines the prop priority of each owned prop based on the prop type of the owned prop and a corresponding relationship between the prop type and the prop priority obtained according to the priority setting operation.

In some embodiments, the prop priority is positively correlated with at least one prop attribute value, such as a prop action strength (for example, changing the level of the attribute value of the virtual object) or a prop action range. The terminal determines an owned prop with the minimum prop action strength or prop action range as the second virtual prop.

In some embodiments, the prop priority of the owned prop of the same type as the first virtual prop is lower than the prop priority of the owned prop of a different type than the first virtual prop. That is, when there is a prop of the same type as the first virtual prop among the owned props, the terminal first determines the second virtual prop from the owned props of the same type as the first virtual prop.

In this embodiment of this application, the terminal determines whether the owned prop needs to be replaced or discarded based on the picking mode indicated by the operation, the owned prop quantity of the virtual object, and whether the virtual object uses the virtual prop. When the owned prop quantity reaches the upper prop quantity limit, the second virtual prop or the third virtual prop that needs to be discarded is determined based on the user operation and the prop priority. Compared with the mode of directly discarding an owned prop in a used state in the related art, the user does not need to control the first virtual object to replace a prop in a used state from a prop that needs to be used to a prop to be discarded without multiple operations. Then the first virtual object is controlled to pick the first virtual prop, and it is also necessary to replace the prop in the used state from the first virtual prop to another prop that needs to be used. On the basis of simplifying the prop picking operations, it is possible to reduce the situation that the owned prop is discarded erroneously by user misoperation.

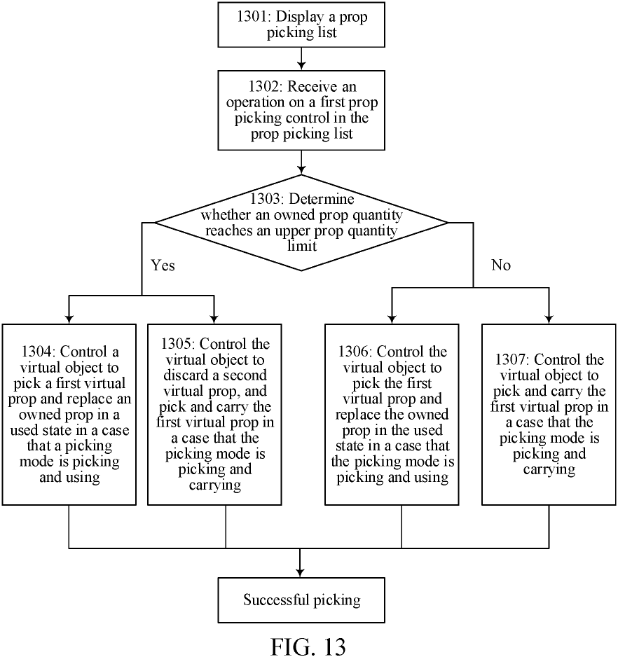

In conjunction with the foregoing embodiments, in a schematic example, a flow of controlling a virtual object to pick virtual props executed by the terminal is shown in FIG. 13. The flow includes the following steps:

Step 1301: Display a prop picking list.

Step 1302: Receive an operation on a first prop picking control in the prop picking list.

Step 1303: Determine whether an owned prop quantity reaches an upper prop quantity limit. If yes, step 1304 or step 1305 is performed. If no, step 1306 or step 1307 is performed.

Step 1304: Control the virtual object to pick a first virtual prop and replace an owned prop in a used state when a picking mode is picking and using.

Step 1305: Control the virtual object to discard a second virtual prop, and pick and carry the first virtual prop when the picking mode is picking and carrying.

When the owned prop quantity reaches the upper prop quantity limit, if the picking mode is picking and using, the second virtual prop in the used state is directly discarded, and the virtual object is controlled to pick and use the first virtual prop. If the picking mode is picking and carrying, the second virtual prop is determined from the owned props in a non-used state, the second virtual prop is discarded, and the virtual object is controlled to pick and carry the first virtual prop.

Step 1306: Control a virtual object to pick a first virtual prop and replace an owned prop in a used state when a picking mode is picking and using.

Step 1307: Control the virtual object to pick and carry the first virtual prop when the picking mode is picking and carrying.

When the owned prop quantity does not reach the upper prop quantity limit, if the picking mode is picking and using, a third virtual prop in a used state is switched into a non-used state, and the virtual object is controlled to pick and use the first virtual prop. If the picking mode is picking and carrying, the virtual object is controlled to directly pick and carry the first virtual prop without changing a prop state of another owned virtual prop.

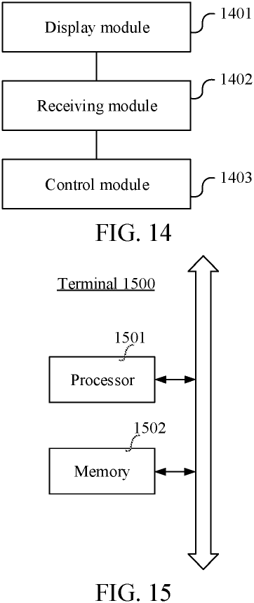

FIG. 14 is a structural block diagram of an apparatus for controlling a virtual object to pick virtual props according to an exemplary embodiment of this application. The apparatus includes:
a display module 1401, configured to display a prop picking list, the prop picking list including prop picking controls of virtual props;
a receiving module 1402, configured to receive an operation on a first prop picking control in the prop picking list, the first prop picking control being a prop picking control of a first virtual prop; and
a control module 1403, configured to control the virtual object to pick the first virtual prop based on a picking mode indicated by the operation, the picking mode of the first virtual prop including picking and using or picking and carrying.

In some embodiments, the receiving module 1402 is further configured to:
receive a first operation on the first prop picking control in the prop picking list; or
receive a second operation on the first prop picking control in the prop picking list, operation types of the first operation and the second operation being different.

The control module 1403 is further configured to:
control, based on the first operation, the virtual object to pick and use the first virtual prop; or
control, based on the second operation, the virtual object to pick and carry the first virtual prop.

In some embodiments, the first operation is a click/tap operation, and the second operation is a swipe operation; or
the first operation is a first swipe operation, the second operation is a second swipe operation, and swipe directions of the first swipe operation and the second swipe operation are different; or
the first operation is a first click/tap operation, the second operation is a second click/tap operation, and clicks/taps of the first click/tap operation and the second click/tap operation are different.

In some embodiments, the first operation or the second operation is a swipe operation.

The apparatus further includes:

the display module 1401, further configured to display a prompt control around the prop picking list, a display position of the prompt control corresponding to a swipe direction of the swipe operation, prop picking information being displayed in the prompt control, and the prop picking information being used for indicating the picking mode of the first virtual prop.

In some embodiments, the receiving module 1402 is further configured to:
display, in response to a long-press operation on the first prop picking control in the prop picking list, prop replacement controls, different prop replacement controls corresponding to different owned props; and
receive a selection operation on a first prop replacement control.

The control module 1403 is further configured to:
determine the picking mode based on a prop state of an owned prop corresponding to the first prop replacement control; and
control the virtual object to pick the first virtual prop based on the picking mode.

In some embodiments, the control module 1403 is further configured to:
determine that the picking mode is picking and using when the prop state is a used state; and
determine that the picking mode is picking and carrying when the prop state is a non-used state.

In some embodiments, the control module 1403 is further configured to:
control the virtual object to pick the first virtual prop based on the picking mode indicated by the operation when an owned prop quantity of the virtual object does not reach an upper prop quantity limit; and
control the virtual object to pick the first virtual prop based on the picking mode indicated by the operation when the owned prop quantity reaches the upper prop quantity limit, and discard a second virtual prop.

In some embodiments, the picking mode is picking and using.

The control module 1403 is further configured to:
control the virtual object to pick and use the first virtual prop when the owned prop quantity does not reach the upper prop quantity limit and the virtual object does not use a virtual prop;
control, when the owned prop quantity does not reach the upper prop quantity limit and a third virtual prop is in a used state, the virtual object to switch the third virtual prop to a non-used state; and control the virtual object to pick and use the first virtual prop.

In some embodiments, the picking mode is picking and using.

The control module 1403 is further configured to:
determine the second virtual prop from owned props in a non-used state when the owned prop quantity reaches the upper prop quantity limit and the virtual object does not use a virtual prop; control the virtual object to discard the second virtual prop; control the virtual object to pick and use the first virtual prop;
control the virtual object to discard the second virtual prop when the owned prop quantity reaches the upper prop quantity limit and the second virtual prop is in a used state; and control the virtual object to pick and use the first virtual prop.

In some embodiments, the picking mode is picking and carrying.

The control module 1403 is further configured to:

control the virtual object to pick and carry the first virtual prop when the owned prop quantity does not reach the upper prop quantity limit.

The control module 1403 is further configured to:
determine the second virtual prop from owned props in a non-used state when the owned prop quantity reaches the upper prop quantity limit;
control the virtual object to discard the second virtual prop; and
control the virtual object to pick and carry the first virtual prop.

In some embodiments, the control module 1403 is further configured to:

determine the second virtual prop from the owned props in the non-used state based on prop priority of the owned props, the prop priority of the second virtual prop being lower than the prop priority of another owned prop.

In some embodiments, the prop priority is determined based on a priority setting operation; or
the prop priority of the owned prop of the same type as the first virtual prop is lower than the prop priority of the owned prop of a different type than the first virtual prop; or
the prop priority is positively correlated with a prop action strength of the owned prop; or
the prop priority is positively correlated with a prop action range of the owned prop.

To sum up, in this embodiment of this application, different operations on a first prop picking control can trigger a virtual object to pick a first virtual prop by different picking modes. The picking modes include picking and using or picking and carrying. A user may control use conditions of an owned prop and the first virtual prop by different operations according to actual requirements. Compared with a mode of controlling a virtual object to directly discard virtual props in a used state in the related art, in response to user requirements for controlling the virtual object to use other virtual props, the user may control the virtual object to pick the first virtual prop and equip the first virtual prop to a corresponding state by performing a corresponding operation on the first prop picking control according to the required picking modes without operating and controlling the virtual object to pick the first virtual prop and operating and controlling the virtual object to switch the first virtual prop into a carried state, thereby simplifying picking operations on virtual props and improving prop picking efficiency.

FIG. 15 is a structural block diagram of a terminal 1500 according to an exemplary embodiment of this application. The terminal 1500 may be a portable mobile terminal, such as a smartphone, a tablet personal computer, a moving picture experts group audio layer III (MP3) player, or a moving picture experts group audio layer IV (MP4) player. The terminal 1500 may also be referred to as user equipment, a portable terminal, or another name.

Generally, the terminal 1500 includes: a processor 1501 and a memory 1502.

The processor 1501 may include one or more processing cores, for example, a 4-core processor or an 8-core processor. The processor 1501 may be implemented in at least one hardware form of a digital signal processor (DSP), a field-programmable gate array (FPGA), and a programmable logic array (PLA). The processor 1501 may further include a main processor and a co-processor. The main processor is a processor for processing data in a wake-up state, and is also referred to as a central processing unit (CPU). The co-processor is a low-power processor for processing data in a standby state. In some embodiments, the processor 1501 may be integrated with a graphics processing unit (GPU). The GPU is responsible for rendering and drawing content to be displayed by a display screen. In some embodiments, the processor 1501 may further include an artificial intelligence (AI) processor. The AI processor is configured to process computing operations related to machine learning.

The memory 1502 may include one or more computer-readable storage media. The computer-readable storage media may be tangible and non-transitory. The memory 1502 may further include a high-speed random access memory and a nonvolatile memory, for example, one or more disk storage devices or flash storage devices. In some embodiments, the non-transitory computer-readable storage medium in the memory 1502 is configured to store at least one instruction. The at least one instruction is used for execution by the processor 1501 to implement the method according to the foregoing embodiment of this application.

It is to be understood by a person skilled in the art that the structure shown in FIG. 15 is not limiting of the terminal 1500 and may include more or fewer assemblies than illustrated, or some assemblies may be combined, or different assembly arrangements may be employed.

This embodiment of this application further provides a non-transitory computer-readable storage medium. The computer-readable storage medium stores at least one program instruction. The at least one program instruction is loaded and executed by a processor to implement the method for controlling a virtual object to pick virtual props according to the above various embodiments.

According to one aspect of this application, a computer program product is provided. The computer program product includes computer instructions. The computer instructions are stored in a non-transitory computer-readable storage medium. A processor of a terminal reads the computer instructions from the computer-readable storage medium. The processor executes the computer instructions to cause the terminal to perform the method for controlling a virtual object to pick virtual props provided in the various implementations in the foregoing aspect.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A method for controlling a virtual object to pick virtual props performed by a terminal, and the method comprising:
displaying a prop picking list, the prop picking list comprising prop picking controls of virtual props;
receiving an operation on a first prop picking control in the prop picking list;
determining a picking mode associated with the operation on the first prop picking control, the picking mode of the first virtual prop comprising (i) picking and using or (ii) picking and carrying; and
controlling the virtual object to pick a first virtual prop based on the picking mode associated with the operation.

2. The method according to claim 1, wherein the receiving an operation on a first prop picking control in the prop picking list comprises:
receiving a first operation on the first prop picking control in the prop picking list; or
receiving a second operation on the first prop picking control in the prop picking list, operation types of the first operation and the second operation being different; and
the controlling the virtual object to pick a first virtual prop based on the picking mode associated with the operation comprises:
controlling, based on the first operation, the virtual object to pick and use the first virtual prop; or
controlling, based on the second operation, the virtual object to pick and carry the first virtual prop.

3. The method according to claim 2, wherein
the first operation is a click/tap operation, and the second operation is a swipe operation; or
the first operation is a first swipe operation, the second operation is a second swipe operation, and swipe directions of the first swipe operation and the second swipe operation are different; or
the first operation is a first click/tap operation, the second operation is a second click/tap operation, and clicks/taps of the first click/tap operation and the second click/tap operation are different.

4. The method according to claim 1, wherein the receiving an operation on a first prop picking control in the prop picking list comprises:
displaying, in response to a long-press operation on the first prop picking control in the prop picking list, prop replacement controls, different prop replacement controls corresponding to different owned props; and
receiving a selection operation on a first prop replacement control; and
the controlling the virtual object to pick the first virtual prop based on a picking mode indicated by the operation comprises:
determining the picking mode based on a prop state of the owned prop corresponding to the first prop replacement control; and
controlling the virtual object to pick the first virtual prop based on the picking mode.

5. The method according to claim 4, wherein the determining the picking mode based on a prop state of the owned prop corresponding to the first prop replacement control comprises:
determining that the picking mode is picking and using when the prop state is a used state; and
determining that the picking mode is picking and carrying when the prop state is a non-used state.

6. The method according to claim 1, wherein the controlling the virtual object to pick a first virtual prop based on the picking mode associated with the operation comprises:
controlling the virtual object to pick the first virtual prop based on the picking mode indicated by the operation when an owned prop quantity of the virtual object does not reach an upper prop quantity limit; and
controlling the virtual object to pick the first virtual prop based on the picking mode indicated by the operation when the owned prop quantity reaches the upper prop quantity limit, and discard a second virtual prop.

7. The method according to claim 6, wherein the picking mode is picking and using; and the controlling the virtual object to pick the first virtual prop based on the picking mode indicated by the operation when an owned prop quantity of the virtual object does not reach an upper prop quantity limit comprises:
controlling the virtual object to pick and use the first virtual prop when the owned prop quantity does not reach the upper prop quantity limit and the virtual object does not use a virtual prop; and
controlling, when the owned prop quantity does not reach the upper prop quantity limit and a third virtual prop is in a used state, the virtual object to switch the third virtual prop to a non-used state; and controlling the virtual object to pick and use the first virtual prop.

8. The method according to claim 6, wherein the picking mode is picking and carrying;
the controlling the virtual object to pick the first virtual prop based on the picking mode indicated by the operation when an owned prop quantity of the virtual object does not reach an upper prop quantity limit comprises:
controlling the virtual object to pick and carry the first virtual prop when the owned prop quantity does not reach the upper prop quantity limit; and
the controlling the virtual object to pick the first virtual prop based on the picking mode indicated by the operation when the owned prop quantity reaches the upper prop quantity limit, and discarding a second virtual prop comprises:
determining the second virtual prop from owned props in a non-used state when the owned prop quantity reaches the upper prop quantity limit;
controlling the virtual object to discard the second virtual prop; and
controlling the virtual object to pick and carry the first virtual prop.

9. A terminal comprising a processor and a memory, the memory storing at least one program, and the at least one program being loaded and executed by the processor and causing the terminal to implement a method for controlling a virtual object to pick virtual props including:
displaying a prop picking list, the prop picking list comprising prop picking controls of virtual props;
receiving an operation on a first prop picking control in the prop picking list;
determining a picking mode associated with the operation on the first prop picking control, the picking mode of the first virtual prop comprising (i) picking and using or (ii) picking and carrying; and
controlling the virtual object to pick a first virtual prop based on the picking mode associated with the operation.

10. The terminal according to claim 9, wherein the receiving an operation on a first prop picking control in the prop picking list comprises:
receiving a first operation on the first prop picking control in the prop picking list; or
receiving a second operation on the first prop picking control in the prop picking list, operation types of the first operation and the second operation being different; and
the controlling the virtual object to pick a first virtual prop based on the picking mode associated with the operation comprises:
controlling, based on the first operation, the virtual object to pick and use the first virtual prop; or
controlling, based on the second operation, the virtual object to pick and carry the first virtual prop.

11. The terminal according to claim 10, wherein
the first operation is a click/tap operation, and the second operation is a swipe operation; or
the first operation is a first swipe operation, the second operation is a second swipe operation, and swipe directions of the first swipe operation and the second swipe operation are different; or
the first operation is a first click/tap operation, the second operation is a second click/tap operation, and clicks/taps of the first click/tap operation and the second click/tap operation are different.

12. The terminal according to claim 9, wherein the receiving an operation on a first prop picking control in the prop picking list comprises:
displaying, in response to a long-press operation on the first prop picking control in the prop picking list, prop replacement controls, different prop replacement controls corresponding to different owned props; and
receiving a selection operation on a first prop replacement control; and
the controlling the virtual object to pick the first virtual prop based on a picking mode indicated by the operation comprises:
determining the picking mode based on a prop state of the owned prop corresponding to the first prop replacement control; and
controlling the virtual object to pick the first virtual prop based on the picking mode.

13. The terminal according to claim 12, wherein the determining the picking mode based on a prop state of the owned prop corresponding to the first prop replacement control comprises:
determining that the picking mode is picking and using when the prop state is a used state; and
determining that the picking mode is picking and carrying when the prop state is a non-used state.

14. The terminal according to claim 9, wherein the controlling the virtual object to pick a first virtual prop based on the picking mode associated with the operation comprises:
controlling the virtual object to pick the first virtual prop based on the picking mode indicated by the operation when an owned prop quantity of the virtual object does not reach an upper prop quantity limit; and
controlling the virtual object to pick the first virtual prop based on the picking mode indicated by the operation when the owned prop quantity reaches the upper prop quantity limit, and discard a second virtual prop.

15. The terminal according to claim 14, wherein the picking mode is picking and using; and
the controlling the virtual object to pick the first virtual prop based on the picking mode indicated by the operation when an owned prop quantity of the virtual object does not reach an upper prop quantity limit comprises:
controlling the virtual object to pick and use the first virtual prop when the owned prop quantity does not reach the upper prop quantity limit and the virtual object does not use a virtual prop; and
controlling, when the owned prop quantity does not reach the upper prop quantity limit and a third virtual prop is in a used state, the virtual object to switch the third virtual prop to a non-used state; and controlling the virtual object to pick and use the first virtual prop.

16. The terminal according to claim 14, wherein the picking mode is picking and carrying;
the controlling the virtual object to pick the first virtual prop based on the picking mode indicated by the operation when an owned prop quantity of the virtual object does not reach an upper prop quantity limit comprises:
controlling the virtual object to pick and carry the first virtual prop when the owned prop quantity does not reach the upper prop quantity limit; and
the controlling the virtual object to pick the first virtual prop based on the picking mode indicated by the operation when the owned prop quantity reaches the upper prop quantity limit, and discarding a second virtual prop comprises:
determining the second virtual prop from owned props in a non-used state when the owned prop quantity reaches the upper prop quantity limit;
controlling the virtual object to discard the second virtual prop; and
controlling the virtual object to pick and carry the first virtual prop.

17. A non-transitory computer-readable storage medium, storing at least one computer program, and the at least one computer program being loaded and executed by a processor of a terminal and causing the terminal to implement a method for controlling a virtual object to pick virtual props including.

18. The non-transitory computer-readable storage medium according to claim 17, wherein the receiving an operation on a first prop picking control in the prop picking list comprises:
receiving a first operation on the first prop picking control in the prop picking list; or
receiving a second operation on the first prop picking control in the prop picking list, operation types of the first operation and the second operation being different; and
the controlling the virtual object to pick a first virtual prop based on the picking mode associated with the operation comprises:
controlling, based on the first operation, the virtual object to pick and use the first virtual prop; or
controlling, based on the second operation, the virtual object to pick and carry the first virtual prop.

19. The non-transitory computer-readable storage medium according to claim 17, wherein the receiving an operation on a first prop picking control in the prop picking list comprises:
displaying, in response to a long-press operation on the first prop picking control in the prop picking list, prop replacement controls, different prop replacement controls corresponding to different owned props; and
receiving a selection operation on a first prop replacement control; and
the controlling the virtual object to pick the first virtual prop based on a picking mode indicated by the operation comprises:
determining the picking mode based on a prop state of the owned prop corresponding to the first prop replacement control; and
controlling the virtual object to pick the first virtual prop based on the picking mode.

20. The non-transitory computer-readable storage medium according to claim 17, wherein the controlling the virtual object to pick a first virtual prop based on the picking mode associated with the operation comprises:
controlling the virtual object to pick the first virtual prop based on the picking mode indicated by the operation when an owned prop quantity of the virtual object does not reach an upper prop quantity limit; and
controlling the virtual object to pick the first virtual prop based on the picking mode indicated by the operation when the owned prop quantity reaches the upper prop quantity limit, and discard a second virtual prop.
